(19) United States
(12) Patent Application Publication
(10) Pub. No.: US 2024/0022070 A1
(43) Pub. Date: Jan. 18, 2024

(54) ACTIVE HARMONIC COMPENSATOR FOR VARIABLE SPEED CHILLERS

(71) Applicant: Carrier Corporation, Jupiter, FL (US)

(72) Inventors: Luis Arnedo, Cary, NC (US); HanJong Kim, Avon, CT (US); Ismail Agirman, Southington, CT (US)

(21) Appl. No.: 16/609,142

(22) PCT Filed: May 9, 2018
(86) PCT No.: PCT/US2018/031785

§ 371 Date: Oct. 28, 2019

Related U.S. Application Data
(60) Provisional application No. 62/503,700, filed on May 9, 2017.

(51) Int. Cl. H02J 3/01; F25B 49/02

(52) U.S. Cl. CPC H02J 3/01; F25B 49/025; F25B 2600/0253

(57) ABSTRACT

An active harmonic filter (AHF) compensation assembly is provided. The AHF compensation assembly includes first wiring carrying input current, second wiring carrying output current and being electrically coupled to the first wiring for reception of the input current and first and second AHFs. The first AHF determines a first harmonic component of the output current and outputs a first signal configured to cancel the first harmonic component to the first wiring at a first location defined along the first wiring. The second AHF determines a second harmonic component of the output current and outputs a second signal configured to cancel the second harmonic component to the first wiring at a second location defined along the first wiring upstream from the first location.

### BACKGROUND

The following description relates to variable speed chillers and, more particularly, to an active harmonic compensator for variable speed chillers.

A chiller is a machine that removes heat from a liquid via a vapor-compression or absorption refrigeration cycle. This liquid can then be circulated through a heat exchanger to cool equipment or may be provided to another process stream. In air conditioning systems, chilled water is typically distributed to heat exchangers or coils in air handling units or other types of terminal devices which cool the air in their respective space(s). The water is then re-circulated back to the chiller to be cooled again. Cooling coils transfer sensible and latent heat from the air to the chilled water, thus cooling and usually dehumidifying the air stream. In industrial applications, chilled water or other liquids from the chiller can be pumped through process or laboratory equipment to cool the laboratory equipment.

In recent years, variable speed drive (VSD) technology has been developed to increase efficiencies of vapor-compression chillers, in particular, and chillers are now commonly designed with VSD capability. Such chillers may be referred to as “variable speed chillers” and are able to efficiently match cooling demands of a system in which they are deployed by executing temperature controls through corresponding controls of motor-compressor assembly rotational speeds.

### BRIEF DESCRIPTION

According to one aspect of the disclosure, an active harmonic filter (AHF) compensation assembly is provided. The AHF compensation assembly includes first wiring carrying input current, second wiring carrying output current and being electrically coupled to the first wiring for reception of the input current and first and second AHFs. The first AHF determines a first harmonic component of the output current and outputs a first signal configured to cancel the first harmonic component to the first wiring at a first location defined along the first wiring. The second AHF determines a second harmonic component of the output current and outputs a second signal configured to cancel the second harmonic component to the first wiring at a second location defined along the first wiring upstream from the first location.

In accordance with additional or alternative embodiments, the AHF compensation assembly further includes a non-linear load a diode electrically interposed between the output current and the non-linear load.

In accordance with additional or alternative embodiments, the non-linear load includes a variable speed chiller.

In accordance with additional or alternative embodiments, the first harmonic component comprises multiple harmonic components and the second harmonic component comprises multiple harmonic components.

In accordance with additional or alternative embodiments, the first harmonic component comprises lowest-intermediate harmonic components and the second harmonic component comprises intermediate-highest harmonic components.

In accordance with additional or alternative embodiments, the AHF compensation assembly further includes an additional AHF which determines an additional harmonic component of the output current and outputs an additional signal configured to cancel the additional harmonic component to the first wiring.

In accordance with additional or alternative embodiments, the first harmonic component includes lowest-first intermediate harmonic components, the second harmonic component includes first intermediate-second intermediate harmonic components and the additional harmonic component includes second intermediate-highest harmonic components.

According to another aspect of the disclosure, a non-linear load operating system is provided. The non-linear load operating system includes non-linear load, first wiring carrying input current, second wiring carrying output current toward the non-linear load and being electrically coupled to the first wiring for reception of the input current and at least first and second active harmonic filters (AHFs) disposed to compensate for harmonic components in the output current. The first AHF is configured to determine a first harmonic component of the output current and to output a first signal configured to cancel the first harmonic component to the first wiring at a first location defined along the first wiring. The second AHF is configured to determine a second harmonic component of the output current and to output a second signal configured to cancel the second harmonic component to the first wiring at a second location defined along the first wiring upstream from the first location.

In accordance with additional or alternative embodiments, the non-linear load operating system further includes a diode electrically interposed between the output current and the non-linear load.

In accordance with additional or alternative embodiments, the non-linear load includes a variable speed chiller.

In accordance with additional or alternative embodiments, the first harmonic component includes multiple harmonic components and the second harmonic component includes multiple harmonic components.

In accordance with additional or alternative embodiments, the first harmonic component includes lowest-intermediate harmonic components and the second harmonic component includes intermediate-highest harmonic components.

In accordance with additional or alternative embodiments, the non-linear load operating system further includes an additional AHF which determines an additional harmonic component of the output current and outputs an additional signal configured to cancel the additional harmonic component to the first wiring.

In accordance with additional or alternative embodiments, the first harmonic component includes lowest-first intermediate harmonic components, the second harmonic component includes first intermediate-second intermediate harmonic components and the additional harmonic component includes second intermediate-highest harmonic components.

According to yet another aspect of the disclosure, a method of operating an active harmonic filter (AHF) compensation assembly is provided. The method includes distributing output current, which is derived from input current, to a non-linear load, determining a first harmonic component of the output current, outputting a first signal configured to cancel the first harmonic component to the input current, determining a second harmonic component of the output current and outputting a second signal configured to cancel the second harmonic component to the input current upstream from the outputting of the signal configured to cancel the first harmonic component.

In accordance with additional or alternative embodiments, the method further includes partitioning active harmonic filters to respectively determine the first and second harmonic components and to respectively output the first and second signals.

In accordance with additional or alternative embodiments, the method further includes updating the partitioning.

In accordance with additional or alternative embodiments, the first harmonic component includes lowest-intermediate harmonic components and the second harmonic component includes intermediate-highest harmonic components.

In accordance with additional or alternative embodiments, the method further includes determining an additional harmonic component of the output current and outputting an additional signal configured to cancel the additional harmonic component to the input current.

In accordance with additional or alternative embodiments, the first harmonic component includes lowest-first intermediate harmonic components, the second harmonic component includes first intermediate-second intermediate harmonic components and the additional harmonic component includes second intermediate-highest harmonic components.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic diagram illustrating an active harmonic filter (AHF) compensation assembly in accordance with embodiments;

FIG. 2 is a schematic diagram illustrating a control algorithm for the AHF compensation assembly of FIG. 1;

FIG. 3 is a graphical depiction of an operational result of employing the AHF compensation assembly of FIG. 1; and

FIG. 4 is a flow diagram illustrating a method of operating an active harmonic filter (AHF) compensation assembly in accordance with embodiments.

### DETAILED DESCRIPTION

Variable speed chillers often include diode bridge front end circuitry and help improve system level part load chiller efficiency, such chillers are considered to be the source of non-linear loads in the systems in which they are deployed. This is due to the fact that the diode bridge input current includes substantial amount of current harmonics that can produce undesirable voltage harmonics that may disrupt the normal operation of adjacent equipment. While there are various methods to mitigate current harmonics including, but not limited to, the use of passive filters, active front end filters and active harmonic filters (AHFs). AHFs work by measuring load side harmonics that are caused by non-linear loads, calculating each harmonic component in real-time and generating an equal magnitude harmonic component with an opposite phase angle to cancel out the original harmonics.

Thus, as will be described below, an active harmonic compensator for a variable speed chiller is provided and includes AHF hardware and control algorithms. The AHF hardware is partitioned into at least first and second partitions designed to optimally handle at least first and second current harmonics. The control algorithms enable the partitions to use a selective harmonic elimination scheme that targets specific current harmonics and, for each current harmonic that is to be cancelled, there is a harmonic regulator that provides the necessary voltage control signal to cancel the current harmonic.

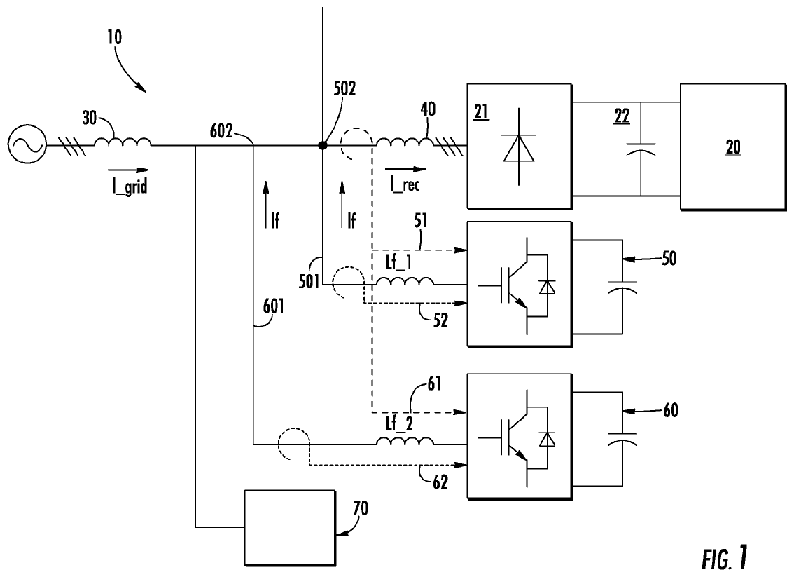

With reference to FIG. 1, a non-linear load operating system 10 is provided. The non-linear load operating system 10 includes a non-linear load 20, first wiring 30 which is disposed and configured to carry input current I_grid, second wiring 40 which is disposed and configured to carry output current I_rec toward the non-linear load 20. The second wiring 40 is electrically coupled to the first wiring 30 and is thus receptive of the input current I_grid from the first wiring 30. The non-linear load 20 may be provided, for example, as a chiller or, more particularly, as a variable speed chiller or as any other suitable non-linear load. In any case, the non-linear load 20 is receptive of the output current I_rec by way of diode 21 and polarized capacitor 22, which are electrically interposed in series between the second wiring 40 and the non-linear load 20.

The non-linear load operating system 10 further includes at least a first active harmonic filter (AHF) 50 and a second AHF 60 which are disposed and configured to compensate for harmonic components in the output current carried by the second wiring 40.

The first AHF 50 is coupled to a first sensing circuit 51 by which the first AHF 50 is configured to sense a first harmonic component of the output current. The first AHF 50 is further configured to determine characteristics of the first harmonic component of the output current and to output a first signal 501 to the first wiring 30. The first signal 501 is configured to cancel the first harmonic component of the output current and is output to the first wiring 30 at a first location 502. The first location 502 is defined along the first wiring 30. The first AHF 50 is also coupled to a second sensing circuit 52 by which the first AHF 50 is configured to sense harmonics of the output first signal 501 as part of a feedback loop that enables the first AHF 50 to efficiently achieve an output of the first signal 501 at a target based on the sensed first harmonic component.

The second AHF 60 is coupled to a first sensing circuit 61 by which the second AHF 60 is configured to sense a second harmonic component of the output current. The second AHF 60 is further configured to determine characteristics of the second harmonic component of the output current and to output a second signal 601 to the first wiring 30. The second signal 601 is configured to cancel the second harmonic component of the output current and is output to the first wiring 30 at a second location 602. The second location 602 is defined along the first wiring 30 upstream from the first location 502. The second AHF 60 is also coupled to a second sensing circuit 62 by which the second AHF 60 is configured to sense harmonics of the output second signal 601 as part of a feedback loop that enables the second AHF 60 to efficiently achieve an output of the second signal 601 at a target based on the sensed second harmonic component.

In accordance with embodiments, the first harmonic component may include multiple harmonic components (e.g., those associated with the lowest harmonics to those associated with intermediate harmonics) that are effectively cancelled out by the first AHF 50 and the second harmonic component may include multiple harmonic components (e.g., those associated with intermediate harmonics to those associated with the highest harmonics) that are effectively cancelled out by the second AHF 60. Thus, for a case in which the non-linear load operating system 10 exhibits output current with at least 5^{th}-31^{st} harmonics (there may, in fact be, 1^{st}-51^{st} harmonics in many cases), as shown in table 1 below, the first AHF 50 may be configured to handle and effectively cancel out the 5^{th}-13^{th} harmonics and the second AHF 60 may be configured to handle and effectively cancel out the 17^{th}-31^{th} harmonics.

TABLE 1
DC Choke + 1% AC reactor and 60 kA SCCO

| | % | | | | | | |
|---|---|---|---|---|---|---|---|
| Harmonic | Nominal | Harmonic Cancellation Effort | | | | | |
| 5 | 27.39 | 13.69 | 0 | 0 | 0 | 0 | 0 |
| 7 | 9.97 | 9.97 | 9.97 | 0 | 0 | 0 | 0 |
| 11 | 7.57 | 7.57 | 7.57 | 7.57 | 0 | 0 | 0 |
| 13 | 4.6 | 4.6 | 4.6 | 4.6 | 4.6 | 0 | 0 |
| 17 | 3.76 | 3.76 | 3.76 | 3.76 | 3.76 | 3.76 | 0 |
| 19 | 2.78 | 2.78 | 2.78 | 2.78 | 2.78 | 2.78 | 2.78 |
| 23 | 2.06 | 2.06 | 2.06 | 2.06 | 2.06 | 2.06 | 2.06 |
| 25 | 1.71 | 1.71 | 1.71 | 1.71 | 1.71 | 1.71 | 1.71 |
| 29 | 1.15 | 1.15 | 1.15 | 1.15 | 1.15 | 1.15 | 1.15 |
| 31 | 1 | 1 | 1 | 1 | 1 | 1 | 1 |
| THD | 30.97 | 19.92 | 14.46 | 10.48 | 7.25 | 5.60 | 4.15 |

| | | | | |
|---|---|---|---|---|
| AHF | Rating for | 30% | Rating for | 5% |
| Rating | 5^{th}-13^{th} | | 11^{th}-25^{th} | |
| % I nom | | | | |

As such, where the first AHF 50 is disposed to handle and effectively cancel the 5^{th}-13^{th} harmonics, the first AHF 50 may have a current rating of 30% of the nominal rectifier current switching at 10 kHz. Meanwhile, where the second AHF 60 is disposed to handle and effectively cancel the 17^{th}-25^{th} harmonics, the second AHF 60 may have a current rating of 5% of the nominal rectifier current switching at 20 kHz. Therefore, while conventional AHFs are designed and built to handle both low and high order harmonics using a high switching frequency which produces high switching losses that have a negative impact on the switching sizes and cooling systems that ultimately translate into higher costs, the partitioning of the first and second AHFs 50 and 60 provides for an optimization of their respective designs whereby low order harmonics are addressed with lower switching frequency devices and high frequency harmonics are addressed by high switching frequency devices.

In accordance with embodiments, where the first AHF 50 is disposed to handle and effectively cancel the 5^{th}-13^{th} harmonics, the first AHF 50 may include silicon insulated-gate bipolar transistors (IGBTs). Such IGBTs can generally be effective in handling high currents but may not be well equipped for high switching frequency operations. Thus, limiting their use for dominant high current low order harmonics provides for an efficient configuration of the non-linear load operating system 10. Similarly, where the second AHF 60 is disposed to handle and effectively cancel the 17^{th}-25^{th} harmonics, the second AHF 60 may include one or more low current devices. Such low current devices may include silicon carbide metal-oxide-semiconductor field-effect transistors (MOSFETs), which are relatively well suited for high switching frequency operations of the non-linear load operating system 10.

With continued reference to FIG. 1, the non-linear load operating system 10 may further include at least an additional AHF 70. The additional AHF 70 is coupled to an additional sensing circuit (not shown) by which the additional AHF 70 is configured to sense an additional harmonic component of the output current. The additional AHF 70 is further configured to determine characteristics of the additional harmonic component of the output current and to output an additional signal (not shown) to the first wiring 30. The additional signal is configured to cancel the additional harmonic component of the output current and is output to the first wiring 30 at an additional location defined along the first wiring 30. The additional AHF 70 is also coupled to another additional sensing circuit (not shown) by which the additional AHF 70 is configured to sense harmonics of the output additional signal as part of a feedback loop that enables the additional AHF 70 to efficiently achieve an output of the additional signal at a target based on the sensed additional harmonic component.

Where the additional AHF 70 is employed, the first harmonic component may include lowest-first intermediate harmonic components, the second harmonic component may include first intermediate-second intermediate harmonic components and the additional harmonic component may include second intermediate-highest harmonic components.

The following description will relate to the embodiments in which only the first and second AHFs 50 and 60 are employed. This is being done for clarity and brevity and is not intended to otherwise limit the scope of the application or the claims.

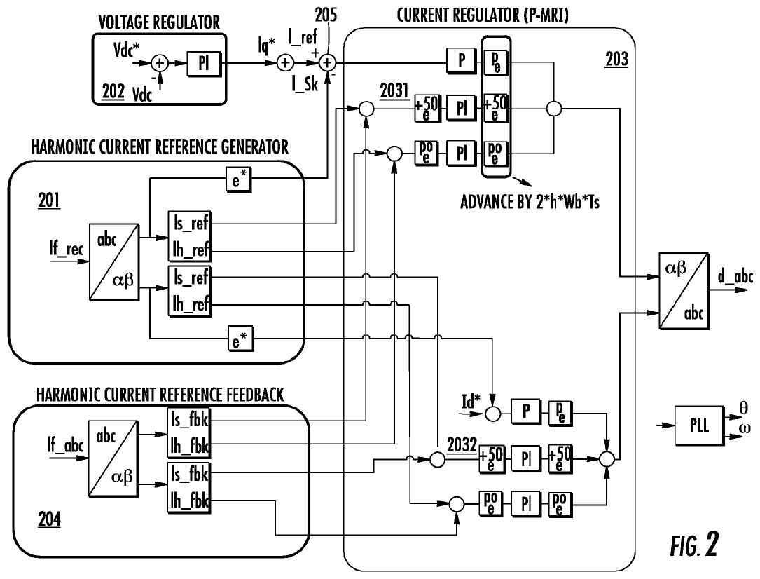

With reference to FIG. 2, control algorithms of the first and second AHFs 50 and 60 are provided. The control algorithms enable the partitioning of the harmonics to the first and second AHFs 50 and 60 and further enable the use of selective harmonic elimination schemes that target specific harmonics (e.g., the multiple harmonic components associated with the lowest to the intermediate harmonics and the multiple harmonic components associated with the intermediate harmonics to the highest harmonics). As shown in FIG. 2, for each harmonic to be cancelled, there is a harmonic regulator that will provide the necessary voltage control signal to cancel the harmonic.

That is, the first AHF 50 includes a harmonic current reference generator 201, a voltage regulator 202, a current regulator 203, which includes first and second parallel regulation units 2031 and 2032, and a harmonic current reference feedback unit 204. The harmonic current reference generator 201 receives rectifier current input from the first sensing circuit 51 and outputs corresponding signals to a summation unit 205, which is electrically interposed between the voltage regulator 202 and the first parallel regulation unit 2031 of the current regulator 203, and to the first and second parallel regulation units 2031 and 2032 of the current regulator 203. Meanwhile, the harmonic current reference feedback unit 204 receives feedback current input from the second sensing circuit 52 and outputs corresponding signals to the first and second parallel regulation units 2031 and 2032 of the current regulator 203. The first and second parallel regulation units 2031 and 2032 of the current regulator 203 output the first signal 501 (see FIG. 1). The second AHF 60 operates in a similar manner.

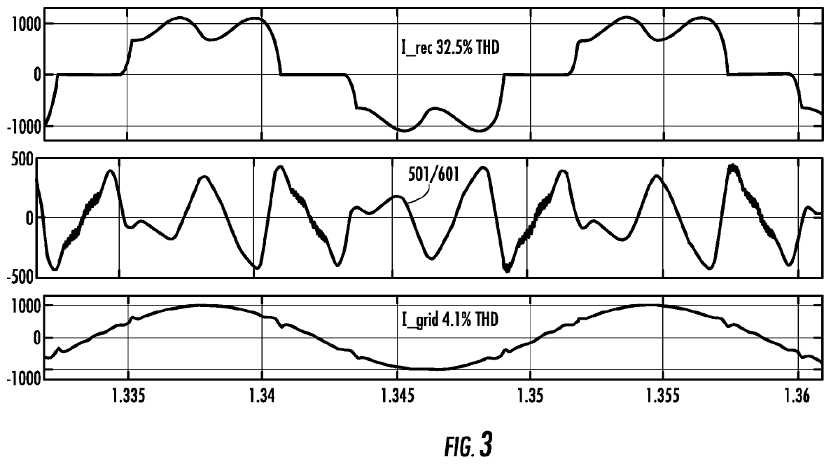

With reference to FIG. 3, it is seen that the reference current of the input current exhibits various harmonics and that the first signal 501 (or the second signal 601) is designed to cancel out at least some of those harmonics. Thus, when the first and second signals 501 and 601 are applied to the input current carried on the first wiring 30, the resulting output current is relatively smooth and lacking in the original harmonics.

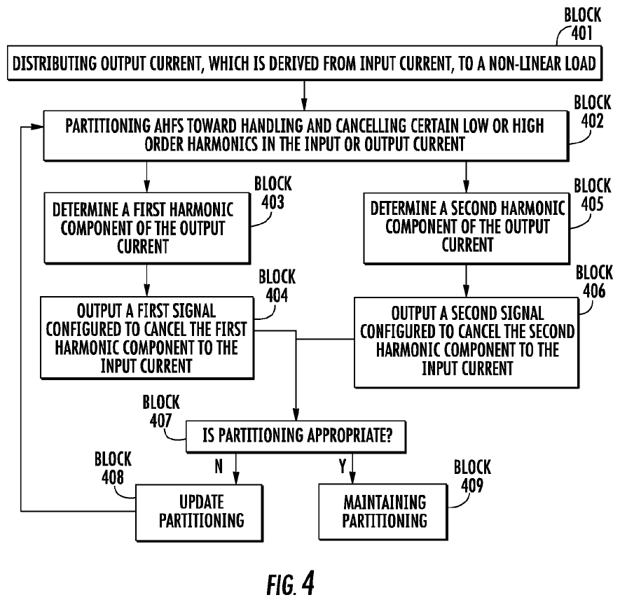

With reference to FIG. 4, a method of operating an active harmonic filter (AHF) compensation assembly is provided. As shown in FIG. 4, the method initially includes distributing output current, which is derived from input current, to a non-linear load (block 401) and partitioning AHFs toward handling and cancelling certain low or high order harmonics in the input or output current (block 402). The method further includes actuating a first partitioned AHF to determine a first harmonic component of the output current (block 403) and to output a first signal configured to cancel the first harmonic component to the input current (block 404) as well as actuating a second partitioned AHF to determine a second harmonic component of the output current (block 405) and to output a second signal configured to cancel the second harmonic component to the input current upstream from the outputting of the second signal (block 406).

In addition, the method may include determining whether the partitioning of block 402 is appropriate based on the performance of the AHF compensation assembly (block 407) and either updating the partitioning (block 408) or maintaining the partitioning (block 409). That is, if an analysis of the AHF compensation assembly reveals that the current partitioning scheme is non-optimized and that AHF performance could be improved by, for example, re-apportioning one of the AHFs toward handling and cancelling certain low or high order harmonics that the one of the AHFs was not previously addressing, the updating of the partitioning of block 408 may be executed. Conversely, in an event that the analysis reveals that the current partitioning scheme is optimized and that AHF performance would not be improved be re-apportionment, the partitioning is maintained as in block 409.

The active harmonic compensator described herein allows for higher chiller efficiency and lower costs. Because the active harmonic compensator exploits natural separations of harmonics and uses switching devices in their respective “sweet” spots. For instance, the high current devices, such as the IGBTs, can effectively handle high currents but may not be well equipped for high switching frequency operations so limiting their use for the dominant high current low order harmonics is a wise approach. On the other hand, the low current devices, such as the MOSFETs, are relatively well suited for high switching frequency operation. The approaches described herein also add flexibility to systems given that some customers may choose to cancel only low order harmonics and other customers with more stringent requirements may choose to add a smaller unit in parallel to add the capability to cancel high frequency harmonics.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An active harmonic filter (AHF) compensation assembly, comprising:
first wiring carrying input current;
second wiring carrying output current and being electrically coupled to the first wiring for reception of the input current;
a first AHF which determines a first harmonic component of the output current and outputs a first signal configured to cancel the first harmonic component to the first wiring at a first location defined along the first wiring; and
a second AHF which determines a second harmonic component of the output current and outputs a second signal configured to cancel the second harmonic component to the first wiring at a second location defined along the first wiring upstream from the first location.

2. The AHF compensation assembly according to claim 1, further comprising:
a non-linear load; and
a diode electrically interposed between the output current and the non-linear load.

3. The AHF compensation assembly according to claim 2, wherein the non-linear load comprises a variable speed chiller.

4. The AHF compensation assembly according to claim 1, wherein:
the first harmonic component comprises multiple harmonic components, and
the second harmonic component comprises multiple harmonic components.

5. The AHF compensation assembly according to claim 1, wherein:
the first harmonic component comprises lowest-intermediate harmonic components, and
the second harmonic component comprises intermediate-highest harmonic components.

6. The AHF compensation assembly according to claim 1, further comprising an additional AHF which determines an additional harmonic component of the output current and outputs an additional signal configured to cancel the additional harmonic component to the first wiring.

7. The AHF compensation assembly according to claim 6, wherein:
the first harmonic component comprises lowest-first intermediate harmonic components,
the second harmonic component comprises first intermediate-second intermediate harmonic components, and
the additional harmonic component comprises second intermediate-highest harmonic components.

8. A non-linear load operating system, comprising:
non-linear load;
first wiring carrying input current;
second wiring carrying output current toward the non-linear load and being electrically coupled to the first wiring for reception of the input current; and
at least first and second active harmonic filters (AHFs) disposed to compensate for harmonic components in the output current,
the first AHF being configured to determine a first harmonic component of the output current and to output a first signal configured to cancel the first harmonic component to the first wiring at a first location defined along the first wiring, and
a second AHF being configured to determine a second harmonic component of the output current and to output a second signal configured to cancel the second harmonic component to the first wiring at a second location defined along the first wiring upstream from the first location.

9. The non-linear load operating system according to claim 8, further comprising a diode electrically interposed between the output current and the non-linear load.

10. The non-linear load operating system according to claim 8, wherein the non-linear load comprises a variable speed chiller.

11. The non-linear load operating system according to claim 8, wherein:
the first harmonic component comprises multiple harmonic components, and
the second harmonic component comprises multiple harmonic components.

12. The non-linear load operating system according to claim 8, wherein:
the first harmonic component comprises lowest-intermediate harmonic components, and
the second harmonic component comprises intermediate-highest harmonic components.

13. The non-linear load operating system according to claim 8, further comprising an additional AHF which determines an additional harmonic component of the output current and outputs an additional signal configured to cancel the additional harmonic component to the first wiring.

14. The non-linear load operating system according to claim 13, wherein:
the first harmonic component comprises lowest-first intermediate harmonic components,
the second harmonic component comprises first intermediate-second intermediate harmonic components, and
the additional harmonic component comprises second intermediate-highest harmonic components.

15. A method of operating an active harmonic filter (AHF) compensation assembly, the method comprising:
distributing output current, which is derived from input current, to a non-linear load;
determining a first harmonic component of the output current;
outputting a first signal configured to cancel the first harmonic component to the input current;
determining a second harmonic component of the output current; and
outputting a second signal configured to cancel the second harmonic component to the input current upstream from the outputting of the second signal.

16. The method according to claim 15, further comprising partitioning active harmonic filters to respectively determine the first and second harmonic components and to respectively output the first and second signals.

17. The method according to claim 16, further comprising updating the partitioning.

18. The method according to claim 15, wherein:
the first harmonic component comprises lowest-intermediate harmonic components, and
the second harmonic component comprises intermediate-highest harmonic components.

19. The method according to claim 15, further comprising:
determining an additional harmonic component of the output current; and
outputting an additional signal configured to cancel the additional harmonic component to the input current.

20. The method according to claim 19, wherein:
the first harmonic component comprises lowest-first intermediate harmonic components,
the second harmonic component comprises first intermediate-second intermediate harmonic components, and
the additional harmonic component comprises second intermediate-highest harmonic components.
